(19) United States
(12) Patent Application Publication
(10) Pub. No.: US 2006/0052165 A1
(43) Pub. Date: Mar. 9, 2006

(54) Storage medium having stored thereon game program, game machine, and input device

(75) Inventor: Keizo Ohta, Kyoto-shi (JP)

Correspondence Address: NIXON & VANDERHYE, P.C., 901 NORTH GLEBE ROAD, 11TH FLOOR, ARLINGTON, VA, 22203, US

(73) Assignee: Nintendo Co., Ltd., Kyoto (JP)

(21) Appl. No.: 11/157,909

(22) Filed: Jun. 22, 2005

(30) Foreign Application Priority Data
Sep. 3, 2004 (JP) 2004-257372

(51) Int. Cl. A63F 13/00

(52) U.S. Cl. 463/36

(57) ABSTRACT

Specified coordinates in a coordinate system are set based on coordinate information outputted from a pointing device, and a direction in which previously set specified coordinates move to currently set specified coordinates is set as an input direction used in game control. Game control is performed based on the input direction, and if previously set specified coordinates and currently set specified coordinates are the same, game control is performed using the same direction as a previous input direction, as a current input direction.

### BACKGROUND OF THE INVENTION

1. Field of the Invention

The present invention relates to a storage medium having stored thereon a game program, a game machine, and an input device. More particularly, the present invention relates to a storage medium having stored thereon a game program for use in a computer game which uses a pointing device such as a touch panel; a game machine; and an input device.

2. Description of the Background Art

Various types of games which use a joystick as a controller have been developed over the years. A joystick is provided with a lever. By a player tilting the lever forward, backward, to the left, or the right, an input in accordance with a direction in which the lever is tilted can be provided. Generally, a game machine processes a direction in which the joystick is tilted, as an input direction. In the case where the player tilts the lever of the joystick in a given direction and holds the lever in such a position, position information of the lever is continuously outputted and processed as an input direction by the game machine. Note that the joystick can be used not only as a controller of a home-use game machine, but also in general personal computers.

As disclosed in Japanese Laid-Open Patent Publications No. 11-53115 (document1) and No. 7-182092 (document2), for example, an input device which is controlled by a player using a touch panel is developed. In an input device disclosed in document 1, as shown in FIGS. 1 and 3 of document 1, the player uses a touch panel, and a direction, in which a predetermined origin on the touch panel is moved to a point being pointed at, and a distance between the origin and the pointed point are used as the moving direction and moving distance of a cursor, respectively. In an input device disclosed in document 2, as shown in FIG. 5 of document 2, a game screen is displayed on a display equipped with a touch panel. An object selected by a touch is caused to move on the game screen according to the vector quantity of a movement of the player's finger touching the touch panel.

It will be convenient if an operation which simulates the operation of a joystick can be realized in a game machine with a touch panel. In this case, required information is a two-axis XY vector value which corresponds to an input value of the joystick. The vector value is expressed as a vector value (sx, sy) in a stick coordinate system. The direction specified by the vector value (sx, sy) represents a direction in which the joystick is tilted. A state in which the joystick is being tilted to its maximum is set to have the length “1”. In this case, sx is from −1 to +1 and sy is from −1 to +1, and thus the length “0” indicates a state in which the joystick is in a neutral (upright) position.

A vector value (sx, sy) in the stick coordinate system can be obtained by the following equations using the origin (ox, oy) on the touch panel and a point (tx, ty) on the touch panel being pressed by the player, which are indicated by a touch panel coordinate system:
sx=(tx−ox)×ratio
sy=(ty−oy)×ratio
Here, the ratio is a conversion ratio which determines a length in the touch panel coordinate system to be regarded as the length “1” in the stick coordinate system. For example, in the case of regarding a point away from the origin by the length “10” in the touch panel coordinate system as the length “1” in the stick coordinate system, the ratio is set to 0.1 (=1÷10).

In the invention as disclosed in the aforementioned document 1, the difference between a point on the touch panel being pressed and the origin is utilized in information processing. If an input method of the invention as disclosed in document 1 is directly applied to an operation which simulates the operation of a joystick, various problems would occur. Referring to FIGS. 6A and 6B, the problems of an input device disclosed in document 1 will be described. Note that, on paper, the left-right direction is taken as the X-axis direction in the touch panel coordinate system (the right direction is taken as the positive direction), and the forward-backward direction is taken as the Y-axis direction (the forward direction is taken as the positive direction). In addition, “O” represents the origin in the touch panel coordinate system. FIGS. 6A and 6B are diagrams illustrating an exemplary operation where the player transitions, with the use of a touch panel, from a directly forward stick input (i.e., an input corresponding to the operation of tilting a joystick directly forward; an input having stick coordinate values: sx=0 and sy>0) to a right direction stick input (i.e., an input corresponding to the operation of tilting the joystick directly to the right; an input having stick coordinate values: sx>0 and sy=0). Note that, in FIGS. 6A and 6B, a “hand” icon schematically represents the player's hand pressing the touch panel.

In FIG. 6A, in the case of performing a directly forward stick input using a touch panel, the player presses a point T1 (t1x, t1y) which is present in the forward direction (a direction which is parallel to the Y axis and in which the Y value increases) from the origin O (ox, oy) provided on the touch panel. Then, using the origin (ox, oy) and the point T1 (t1x, t1y), a vector value V1 of the directly forward direction is obtained.

In FIG. 6B, in the case of performing a right direction stick input using a touch panel, the player needs to press a point T2 (t2x, t2y) which is present in the right direction (a direction which is parallel to the X axis and in which the X value increases) from the origin O (ox, oy) provided on the touch panel. Then, using the origin (ox, oy) and the point T2 (t2x, t2y), a vector value V2 of the right direction is obtained. Thus, in order to transition, with the use of a touch panel, from the directly forward stick input to the right direction stick input, the player needs to press the touch panel from the point T1 to a touch point present at the right backward of the point T1, as shown by a broken line in the drawing. That is, in the case of performing the right direction stick input, the player may want to move the pressing point from a currently pointed point to a point present in the right direction from the currently pointed point (i.e., a direction which is parallel to the X axis and in which the X value increases), as such an operation is convenient for the player; however, if the currently pointed point is displaced from the origin in the forward-backward direction, simply moving the pressing point in the right direction from the currently pointed point does not provide the intended right direction stick input. For example, if the currently pointed point is present in the forward direction from the origin, in order to perform the right direction stick input, the currently pointed point needs to be moved in the right backward direction, which may cause operational confusion due to a difference between the pressing point that the player is supposed to press and the actual pressing point, and therefore, the player needs to constantly check the position of the origin. In the case of the actual joystick, there is provided a frame for guiding the lever. Hence, for example, if a tilting force in the right direction is applied to the lever being tilted to its maximum in the forward direction, the lever naturally moves in the right backward direction along the guide, and is eventually positioned at its maximum in the right direction. However, in the case of realizing, with the use of a touch panel, an operation which simulates a joystick, since there is no guide such as the one described above, the player needs to intentionally move the pressing point in the right backward direction. In the case of the actual joystick, since the player can perceive the tilt state of the lever by the sense of touch with the finger or hand, the player does not need to check the origin of the joystick with his/her eyes; however, in the case of realizing, with the use of a touch panel, an operation which simulates the operation of a joystick, since the player cannot perceive the origin by the sense of touch with his/her finger, the player needs to check the position of the origin with his/her eyes.

Document 1 also discloses a method of causing a cursor to move with respect to a path along which the player's finger moves. Document 2 also discloses a method of causing an object selected by a touch to move on a game screen according to the vector of a movement of the player's finger touching a touch panel. In these methods, however, since an input cannot be provided unless the player's finger moves, an input which simulates the input of a joystick cannot be realized. This is because in the actual joystick, when the lever is held in a given position, a certain input is continuously outputted. More specifically, in the case of causing a game object to move according to the vector of a movement of the finger touching the touch panel, in order to cause the game object to move, the finger needs to keep moving.

### SUMMARY OF THE INVENTION

Therefore, an object of the present invention is to provide a storage medium having stored thereon a game program which allows a player to perform, with the use of a pointing device, an operation simulating the operation of a joystick, which prevents operational confusion by conforming actual operations to the player's intended operations, and which achieves an improvement in response; a game machine; and an input device.

The present invention has the following features to attain the object mentioned above. It is to be understood that reference numerals, step numbers (step is abbreviated as “S” and only step numbers are provided), etc., in parentheses illustrate the corresponding relationship with an embodiment, which will be described later, and are provided to assist in the understanding of the present invention, and thus are not intended to limit the scope of the present invention.

A first aspect of the present invention is directed to a storage medium having stored thereon a game program to be executed by a computer (21) of a game machine (1) controlled by a pointing device (13). The pointing device outputs coordinate information (tx, ty) specified by an operation of a player and based on a given coordinate system (touch panel coordinate system). The game program causes the computer to perform a specified-coordinate setting step (S43), an input-direction setting step (S46, S47), and a game control step (S49, etc.). At the specified-coordinate setting step, specified coordinates (contact point (tx, ty)) in the coordinate system are set based on coordinate information outputted from the pointing device. At the input-direction setting step, a direction (da) in the coordinate system in which specified coordinates previously set (previous contact point (ox, oy)) at the specified-coordinate setting step move to currently set specified coordinates is set as an input direction (sa) used in game control. At the game control step, game control is performed based on the input direction set at the input-direction setting step, and if specified coordinates previously set at the specified-coordinate setting step and currently set specified coordinates are the same (“YES” at S45), game control is performed using, as a current input direction, a same direction as a previous input direction set at the input-direction setting step. Note that the pointing device is an input device for specifying an input position or coordinates on a screen, and is realized by, for example, a touch panel, a mouse, a track pad, a track ball, or the like. A coordinate system used by an input device is a touch panel coordinate system or a screen coordinate system.

In a second aspect based on the first aspect, at the game control step, only when same coordinate information is continuously outputted from the pointing device, game control may be performed using, as a current input direction, a same direction as a previous input direction set at the input-direction setting step.

In a third aspect based on the first aspect, the game program may further cause the computer to perform an input-direction storing step (S48). At the input-direction storing step, the input direction set at the input-direction setting step is updated and stored according to the setting of the input direction. At the input-direction setting step, if specified coordinates previously set at the specified-coordinate setting step and currently set specified coordinates are different (“NO” at S45), a direction in the coordinate system in which the previously set specified coordinates move to the currently set specified coordinates may be set as the input direction and the input direction may be stored at the input-direction storing step. At the game control step, game control may be performed based on the input direction stored at the input-direction storing step.

In a fourth aspect based on the third aspect, at the input-direction storing step, if output of coordinate information from the pointing device has ended, the stored input direction may be initialized (S51).

In a fifth aspect based on the third aspect, the game program may further cause the computer to perform a specified-coordinate storing step (S44). At the specified-coordinate storing step, specified coordinates set at the specified-coordinate setting step are stored. At the input-direction setting step, if specified coordinates previously set at the specified-coordinate setting step and stored at the specified-coordinate storing step are different from specified coordinates currently set at the specified-coordinate setting step, the input direction may be set.

In a sixth aspect based on the first aspect, the game program may further cause the computer to perform a peripheral area setting step. At the peripheral area setting step, a peripheral area (tolerance area) is set at a periphery of the specified coordinates set based on coordinate information outputted from the pointing device. At the specified-coordinate setting step, if a position indicated by coordinate information newly outputted from the pointing device is within the peripheral area, the specified coordinates may not be changed, and if the position indicated by the newly outputted coordinate information is outside the peripheral area, the specified coordinates may be changed based on the position indicated by the coordinate information.

In a seventh aspect based on the first aspect, at the game control step, if output of coordinate information from the pointing device has ended, game control may be continuously performed based on the input direction which had been set before the output of coordinate information ended.

An eighth aspect is directed to a game machine controlled by a pointing device. The pointing device outputs coordinate information specified by an operation of a player and based on a given coordinate system. The game machine comprises specified-coordinate setting means, input-direction setting means, and game control means. The specified-coordinate setting means sets specified coordinates in the coordinate system based on coordinate information outputted from the pointing device. The input-direction setting means sets, as an input direction used in game control, a direction in the coordinate system in which specified coordinates previously set by the specified-coordinate setting means move to currently set specified coordinates. The game control means performs game control based on the input direction set by the input-direction setting means, and performs, if specified coordinates previously set by the specified-coordinate setting means and currently set specified coordinates are the same, game control using, as a current input direction, a same direction as a previous input direction set by the input-direction setting means.

A ninth aspect is directed to an input device for inputting information to a game machine. The game machine performs game control based on an input direction indicating a direction in a given coordinate system. The input device comprises coordinate information output means (13), specified-coordinate setting means, and input-direction setting means. The coordinate information output means outputs coordinate information which is specified by an operation of a player and based on the coordinate system. The specified-coordinate setting means sets specified coordinates in the coordinate system based on coordinate information outputted from the coordinate information output means. The input-direction setting means sets, as an input direction used in game control, a direction in the coordinate system in which specified coordinates previously set by the specified-coordinate setting means move to currently set specified coordinates. The game machine performs game control based on the input direction set by the input-direction setting means, and performs, if specified coordinates previously set by the specified-coordinate setting means and currently set specified coordinates are the same, game control using, as a current input direction, a same direction as a previous input direction set by the input-direction setting means.

A tenth aspect is directed to a storage medium having stored thereon a program to be executed by a computer of an information processing device controlled by a pointing device. The pointing device outputs coordinate information specified by an operation of a user and based on a given coordinate system. The program causes the computer to perform a specified-coordinate setting step, an input-direction setting step, and an operation processing step. At the specified-coordinate setting step, specified coordinates in the coordinate system are set based on coordinate information outputted from the pointing device. At the input-direction setting step, a direction in the coordinate system in which specified coordinates previously set at the specified-coordinate setting step move to currently set specified coordinates is set as an input direction used in operation processing. At the operation processing step, operation processing is performed based on the input direction set at the input-direction setting step, and if specified coordinates previously set at the specified-coordinate setting step and currently set specified coordinates are the same, operation processing is performed using, as a current input direction, a same direction as a previous input direction set at the input-direction setting step.

According to the first aspect, by the player moving specified coordinates which are set using a pointing device, in a desired direction, an input direction which is used in game control can be determined without the need for the player to be aware of the position of the origin. Specifically, an operation direction specified by the player using a pointing device serves as an input direction, and thus an input which conforms to the player's intended operation and has a fast response time can be realized. In addition, in the case where the player continues to specify the same specified coordinates using a pointing device, game control in which the same input direction is repeatedly used is performed. Accordingly, the same game processing is realized as processing performed during the operation of continuously outputting, when the lever of a joystick is held in a given position, a certain input; therefore, the player can operate a pointing device as if he/she were operating a joystick. Further, since the origin which is conventionally set on a pointing device is not set in the present invention, and a contact point immediately before the current contact point is treated as the origin, the player can intuitively grasp the origin set on the pointing device; accordingly, without visually checking the pointing device, the player can operate the pointing device as if he/she were operating a joystick.

According to the second aspect, in the case where the player continues to specify the same specified coordinates using a pointing device, game control in which the same input direction is repeatedly used is performed. Accordingly, the same game processing is realized as processing performed during the operation of continuously outputting, when the lever of a joystick is held in a given position, a certain input; therefore, the player can operate the pointing device as if he/she were operating a joystick.

According to the third aspect, if specified coordinates which are different from previously set specified coordinates are set, a new input direction is set, and if specified coordinates which are the same as previously set specified coordinates are set, an input direction is stored without being updated. At the game control step, since a stored input direction is used, in the case where the player continues to specify the same specified coordinates using a pointing device, game control in which the same input direction is repeatedly used can be easily realized.

According to the fourth aspect, since an input direction used in game control is initialized at the time when the player stops operating a pointing device, the player can easily perform the initialization of the input direction.

According to the fifth aspect, since specified coordinates are stored, an input direction which is set using chronologically different specified coordinates can be easily determined.

According to the sixth aspect, even if coordinate information specified by a pointing device varies and does not specify one specific point, specified coordinates to be used in processing are determined independently of the coordinate information, and thus a position indicated by the coordinate information can be given tolerance.

According to the seventh aspect, since the input direction is continuously outputted, the player can enjoy a game without the player's operation being interrupted. It becomes unnecessary for the player to continuously perform the same operation for a long period of time; namely, an operation in which the same operation is continuously performed is facilitated.

According to the game machine, input device, and storage medium having stored thereon a program of the present invention, the same advantageous effects as those obtained by the aforementioned storage medium having stored thereon a game program can be obtained.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an external view illustrating a game machine 1 which executes a game program according to an embodiment of the present invention;

FIG. 2 is a block diagram illustrating an internal configuration of the game machine 1 of FIG. 1;

FIG. 3 is a flowchart showing operations processed by the game machine 1 executing the game program according to the embodiment of the present invention;

FIG. 4 is a flowchart of a subroutine showing detailed operations performed during an “initialization process for the start of touch” of step 42 in FIG. 3;

FIGS. 5A and 5B are diagrams illustrating an exemplary change in stick direction which is brought about by repeating processing based on the flowchart shown in FIG. 3; and

FIGS. 6A and 6B are diagrams illustrating an exemplary conventional operation where a player transitions, with the use of a touch panel, from a directly forward input to a right direction input.

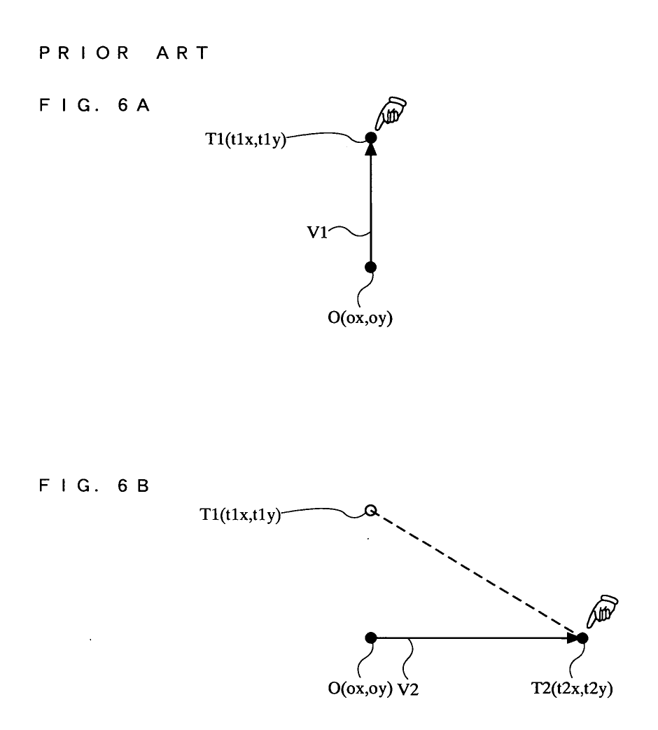

### DESCRIPTION OF THE PREFERRED EMBODIMENTS

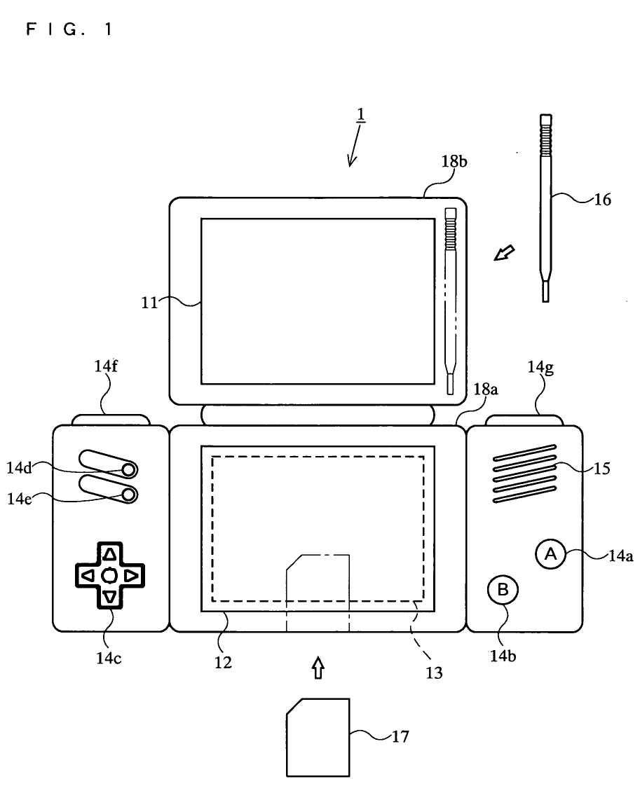

Referring to the drawings, a game machine which executes a game program according to an embodiment of the present invention will be described. FIG. 1 is an external view illustrating a game machine 1 which executes a game program of the present invention. Here, as an example of the game machine 1, a portable game machine is used.

In FIG. 1, the game machine 1 of the present embodiment has two liquid crystal displays (LCDs) 11 and 12 accommodated in a housing 18 at predetermined arrangement positions. Specifically, in the case where a first liquid crystal display (hereinafter referred to as an “LCD”) 11 and a second LCD 12 are accommodated so as to be arranged horizontally, the housing 18 is composed of a lower housing 18a and an upper housing 18b, and the upper housing 18b is supported so as to be freely pivotable about a part of an upper side of the lower housing 18a. The upper housing 18b has a planar shape slightly larger than a planar shape of the first LCD 11, and has an opening formed therein so that a display screen of the first LCD 11 is exposed from a principal plane of the upper housing 18b. The lower housing 18a has a planar shape which is selected to be horizontally longer than the planar shape of the upper housing 18b, and has an opening formed in a substantially central portion thereof in a horizontal direction so that a display screen of the second LCD 12 is exposed therefrom. Further, sound transmitting holes of a speaker 15 are formed in either of left and right portions of the lower housing 18a sandwiching the second LCD 12, and control switches 14 are mounted on both the left and right portions.

The control switches 14 include an operation switch (A button) 14a and an operation switch (B button) 14b which are mounted on a principal plane of the right portion of the lower housing 18a; a direction specification switch (cross key) 14c, a start switch 14d, and a select switch 14e which are mounted on a principal plane of the left portion of the lower housing 18a; and side switches 14f and 14g. The operation switches 14a and 14b are used to provide, for example, an input instructing to pass or shoot in a sport game such as a soccer game; an input instructing to jump, punch, or move a weapon in an action game; or an input instructing to obtain an item or to select and determine a weapon or a command in a role-playing game (RPG) or a simulation RPG. The direction specification switch 14c is used to specify a direction in a game screen; specifically, the direction specification switch 14c is used to specify, for example, the moving direction of a player object (or a player character) which is controllable by a player using the control switches 14, or the moving direction of a cursor. The side switch (L button) 14f and the side switch (R button) 14g are provided to the upper side surfaces of the left and right portions of the lower housing 18a, respectively. Other operation switches may be additionally provided if necessary.

On a top surface of the second LCD 12, a touch panel 13 (a region surrounded by a broken line in FIG. 1) is mounted as an exemplary input device of the present invention. The touch panel 13 may be of any type (for example, a resistance film type, an optical type (infrared type), or a capacitance coupling type). The touch panel 13 is an exemplary pointing device which detects, when a pressing operation, a moving operation, or a dragging operation is performed on a top surface of the touch panel 13 using a stylus 16 (or the finger), a coordinate position of the stylus 16 and outputs coordinate data.

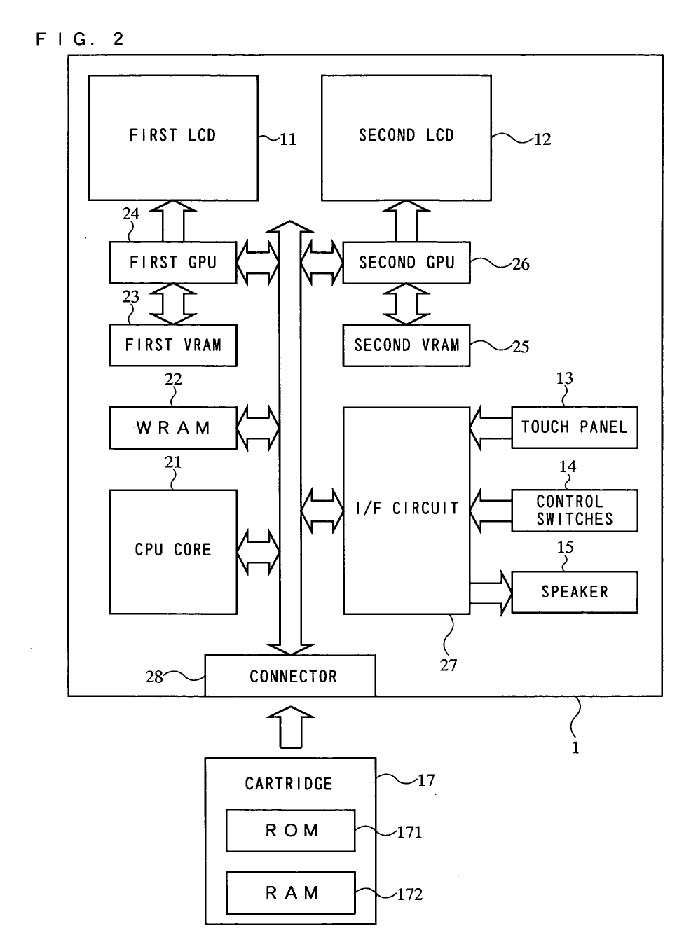

If necessary, a storage slot (a region surrounded by a dash-dot-dot line in FIG. 1) for storing the stylus 16 which is used to control the touch panel 13 may be formed in one side of the periphery of the upper housing 18b. The stylus 16 is stored in the storage slot. A cartridge insertion section (a region surrounded by a dash-dot line in FIG. 1) is formed in a part of a side surface of the lower housing 18a to removably mount a game cartridge 17 (hereinafter simply referred to as the “cartridge 17”) which includes a memory (e.g., ROM) having stored therein a game program. The cartridge 17 is an information storage medium for storing a game program. As the cartridge 17, for example, a nonvolatile semiconductor memory such as ROM or flash memory is used. A connector (see FIG. 2) for electrically connecting between the cartridge 17 and the game machine 1 is mounted in the cartridge insertion section. Further, an electronic circuit board having mounted thereon various electronic components such as a CPU is provided in the lower housing 18a (or the upper housing 18b). Note that an information storage medium for storing a game program is not limited to the aforementioned nonvolatile semiconductor memory, and it is also possible to use a CD-ROM, a DVD, or other optical disk storage media of a similar type.

Now, referring to FIG. 2, an internal configuration of the game machine 1 will be described. FIG. 2 is a block diagram illustrating the internal configuration of the game machine 1.

In FIG. 2, a CPU core 21 is mounted on an electronic circuit board provided in the housing 18. A connector 28 for connecting between a cartridge 17 and the game machine 1, and also an input/output interface (I/F) circuit 27, a first graphics processing unit (first GPU) 24, a second graphics processing unit (second GPU) 26, and a working RAM (WRAM) 22 are connected to the CPU core 21 via a predetermined bus.

The cartridge 17 is removably connected to the connector 28. As described above, the cartridge 17 is a storage medium for storing a game program. Specifically, the cartridge 17 contains a ROM 171 for storing a game program and a RAM 172 for rewritably storing backup data. A game program stored in the ROM 171 of the cartridge 17 is loaded into the WRAM 22, and the game program loaded into the WRAM 22 is executed by the CPU core 21. Temporary data obtained as a result of the CPU core 21 executing the game program, or data for generating an image is stored in the WRAM 22.

As described above, in the ROM 171, a game program consisting of a series of instructions and a collection of data in a form executable by the computer of the game machine 1, particularly by the CPU core 21 is stored. This program is appropriately read into the WRAM 22 and executed. Note that although, in the present embodiment, a game program, etc., are stored in the cartridge 17, the game program may be supplied on other media or through a communication line.

A touch panel 13, control switches 14, and a speaker 15 are connected to the I/F circuit 27. The speaker 15 is arranged underneath the aforementioned sound transmitting holes.

A first video RAM (hereinafter referred to as “VRAM”) 23 is connected to the first GPU 24, and a second video RAM (hereinafter referred to as “VRAM”) 25 is connected to the second GPU 26. The first GPU 24 generates a first game image in response to an instruction from the CPU core 21 and based on data for generating an image which is stored in the WRAM 22, and then renders the first game image in the first VRAM 23. The second GPU 26 generates a second game image in response to an instruction from the CPU core 21 and based on data for generating an image which is stored in the WRAM 22, and then renders the second game image in the second VRAM 25.

The first GPU 24 is connected to a first LCD 11, and the second GPU 26 is connected to a second LCD 12. The first GPU 24 outputs to the first LCD 11 the first game image rendered in the first VRAM 23 in response to an instruction from the CPU core 21. The first LCD 11 then displays the first game image outputted from the first GPU 24. The second GPU 26 outputs to the second LCD 12 the second game image rendered in the second VRAM 25 in response to an instruction from the CPU core 21. The second LCD 12 then displays the second game image outputted from the second GPU 26.

The I/F circuit 27 is a circuit for passing data between the CPU 21 and an external input/output device such as the touch panel 13, the control switches 14, or the speaker 15. The touch panel 13 (including a device driver for the touch panel) has a touch panel coordinate system associated with a coordinate system of the second VRAM 25, and outputs data of a set of position coordinates corresponding to a position inputted (indicated) by the stylus 16 or the like. For example, the resolution of a display screen of the second LCD 12 is 256 dots×192 dots and the detection accuracy of the touch panel 13 is also 256 dots×192 dots corresponding to the resolution of the display screen of the second LCD 12. Note that the detection accuracy of the touch panel 13 may be lower or higher than the resolution of the display screen of the second LCD 12.

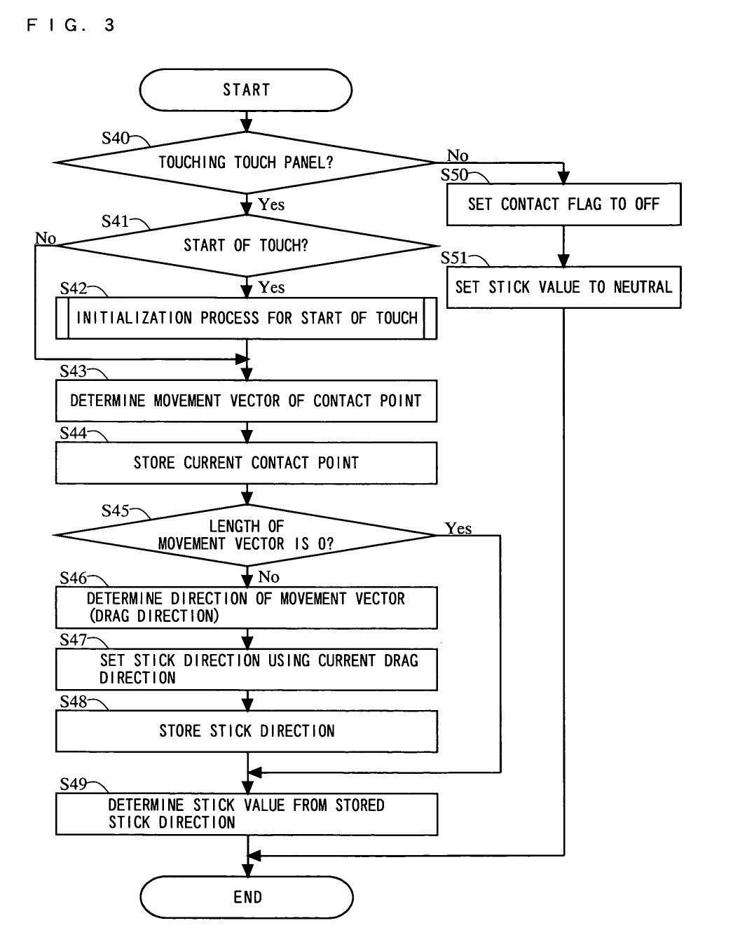

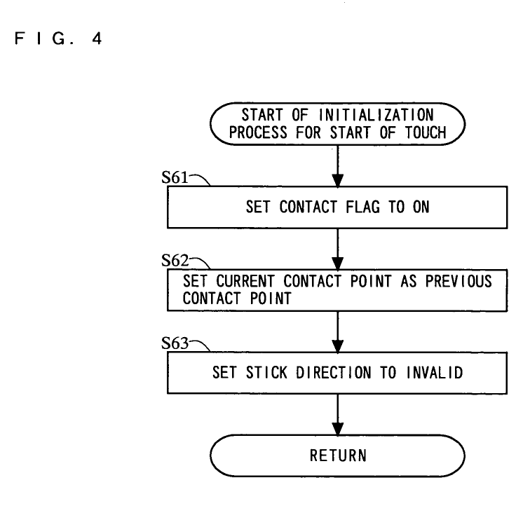

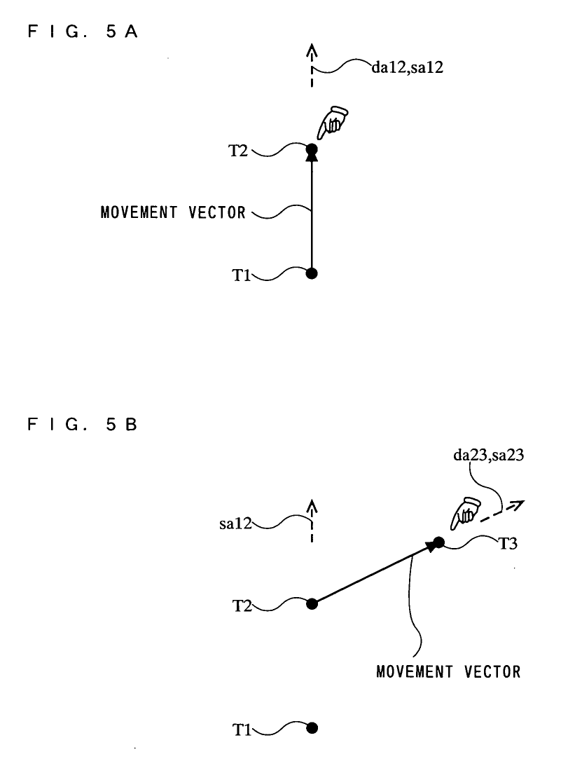

Now, referring to FIGS. 3 to 5A and 5B, processing based on information inputted from the touch panel 13 will be described which is performed by the game machine 1 executing a game program of the present invention. FIG. 3 is a flowchart showing operations processed by the game machine 1 executing the game program. FIG. 4 is a flowchart of a subroutine showing detailed operations performed during an “initialization process for the start of touch” of step 42 in FIG. 3. FIGS. 5A and 5B are diagrams illustrating an exemplary touch operation processed by the operations based on the flowchart of FIG. 3. Note that a program which performs these processes is included in the game program stored in the ROM 171; when the power of the game machine 1 is turned on, the program is read into the WRAM 22 from the ROM 171 and then executed by the CPU core 21.

First, when the power (not shown) of the game machine 1 is turned on, a boot program (not shown) is executed by the CPU core 21, whereby a game program stored in the cartridge 17 is loaded into the WRAM 22. The loaded game program is then executed by the CPU core 21, whereby steps (which are abbreviated as “S” in FIGS. 3 and 4) shown in FIG. 3 are performed. By executing the game program, a game image and the like according to the game program are rendered in the first LCD 11 and the second LCD 12. Here, a detailed description about the content of the game will be omitted, and processing based on information inputted from the touch panel 13 will be described in detail.

In FIG. 3, the CPU core 21 determines whether the player is in contact with the touch panel 13 (step 40). As described above, the touch panel 13 has a touch panel coordinate system, and outputs data of a set of position coordinates corresponding to a position inputted (indicated) by the stylus 16, the player's finger, or the like. Specifically, at step 40, the CPU core 21 detects whether there is data of a set of position coordinates outputted from the touch panel 13 (including a device driver for controlling the touch panel 13). If the player is not in contact with the touch panel 13, the CPU core 21 sets a contact flag to off (step 50), sets a stick value to neutral (sx=0, sy=0) (step 51), and completes the processing of the flowchart. On the other hand, if the player is in touch with the touch panel 13, the CPU core 21 proceeds processing to the next step 41.

At step 41, the CPU core 21 determines whether the touch operation performed on the touch panel 13 by the player is the start of touch (i.e., whether a state is changed from a non-touch state to a touch state). The CPU core 21 can determine whether the touch operation is the start of touch based on the setting of the contact flag, either on or off, as will become clear from the description provided below. If the touch operation is the start of touch (the contact flag is off), the CPU core 21 proceeds processing to the next step 42. On the other hand, if the touch operation is not the start of touch (i.e., the touch operation is continuously performed; the contact flag is on), the CPU core 21 proceeds processing to the next step 43.

At step 42, the CPU core 21 performs an initialization process for the start of touch. Referring to the subroutine shown in FIG. 4, the initialization process for the start of touch will be described below.

In FIG. 4, the CPU core 21 sets the contract flag to on (step 61). The CPU core 21 then sets a contact point on the touch panel 13 on which the player is currently performing a touch operation (hereinafter simply referred to as a “contact point”), as a previous contact point on the touch panel 13 (step 62). Specifically, in the aforementioned touch panel coordinate system, if the current contact point is (tx, ty) and the previous contact point is (ox, oy), the CPU core 21 sets the coordinates of the previous contact point such that
ox=tx
oy=ty.

Subsequently, the CPU core 21 sets a stick direction sa to invalid (step 63), and completes the processing of the subroutine. Specifically, the CPU core 21 sets the stick direction sa to invalid such that
sa=−1.

Referring back to FIG. 3, at step 43, the CPU core 21 determines the movement vector of the contact point. Specifically, the CPU core 21 determines the movement vector (vx, vy) from the difference between the current contact point and the previous contact point. In the aforementioned touch panel coordinate system, if the current contact point is (tx, ty) and the previous contact point is (ox, oy), the CPU core 21 determines the movement vector (vx, vy) such that
vx=tx−ox
vy=ty−oy.

Subsequently, the CPU core 21 stores the current contact point on the touch panel 13 on which the player is currently performing a touch operation, as a previous contact point on the touch panel 13 (step 44). Specifically, in the aforementioned touch panel coordinate system, if the current contact point is (tx, ty) and the previous contact point is (ox, oy), the CPU core 21 stores the coordinates of the previous contact point such that
ox=tx
oy=ty.

The CPU core 21 then determines whether the length of the movement vector (vx, vy) is 0 (step 45). If the length of the movement vector is 0 (i.e., vx=0, vy=0), the CPU core 21 proceeds processing to the next step 49. On the other hand, if the length of the movement vector is not 0, the CPU core 21 proceeds processing to the next step 46.

At step 46, the CPU core 21 determines the direction of the movement vector (vx, vy) (hereinafter referred to as the “drag direction da”). Specifically, the CPU core 21 determines the drag direction da such that
da=a tan(vx, vy).
Note that a tan(x, y) is a function which returns a value in the range from 0 to less than 360 in degrees from a two-dimensional vector value (x, y), and determines the inverse tangent of the vector.

Next, the CPU core 21 sets the stick direction sa using the current drag direction da (step 47). Specifically, the CPU core 21 sets the stick direction sa such that sa=da.

The CPU core 21 then stores the stick direction sa having been set at the foregoing step 47 (step 48), and proceeds processing to the next step 49. If a stick direction sa being already stored is present, the CPU core 21 updates the stick direction sa being already stored, with the stick direction sa having been set at the foregoing step 47.

The CPU core 21 performs step 49 if, at the foregoing step 45, the length of the movement vector is determined to be 0, or after the stick direction sa has been stored at the foregoing step 48. At step 49, the CPU core 21 determines a stick value (sx, sy) from the currently stored stick direction sa, and completes the processing of the flowchart. Specifically, the CPU core 21 determines the stick value (sx, sy) such that
sx=cos(sa)
sy=sin(sa).
If the stick direction sa is invalid (sa=−1), the CPU core 21 sets the stick value to neutral (sx=0, sy=0).

The stick value determined at step 49 is used in game processing as with the case of conventional games which use a joystick. In the above-described flowchart, an operation which simulates the operation of a joystick is realized using the touch panel 13, and necessary information is a two-axis XY vector value which corresponds to an input value of the joystick. This vector value is expressed as a stick value (sx, sy) in the stick coordinate system. The direction specified by the stick value (sx, sy) represents a direction in which the joystick is tilted. A situation where sx and sy, each being set to a value from −1 to +1, are both 0 indicates that the joystick is in a neutral (upright) state. For example, in the case where the player continues a touch operation using the same point on the touch panel 13 as a contact point, the length of the movement vector becomes 0 (“Yes” at step 45), and a stick direction sa being stored is repeatedly used without being updated. That is, by repeating the above-described flowchart according to the processing cycle, the same stick value is repeatedly obtained. Therefore, in the game machine 1, game processing is repeatedly performed using the same stick value; that is, the same game processing is realized as processing performed during the operation of continuously outputting, when the lever of the joystick is held in a given position, a certain input.

Referring to FIGS. 5A and 5B, an exemplary change in stick direction which is set to the same direction as a drag direction will be described below. FIGS. 5A and 5B are diagrams illustrating an exemplary change in stick direction which is set to the same direction as a drag direction.

In FIG. 5A, it is assumed that by the player performing a touch operation on the touch panel 13 such that the player first touches a contact point T1 from a non-touch state and then moves his/her finger to a contact point T2 with the finger continuously touching the touch panel, a previous contact point T1 and a current contact point T2 are set. In this case, the vector from the previous contact point T1 to the current contact point T2 is set as a movement vector. Then, the direction specified by the movement vector from the previous contact point T1 to the current contact point T2 is set as a drag direction da12. A stick direction sa12 is the same as the drag direction da12. Namely, the direction in which the first contact point T1 moves to the contact point T2 is set as an initial stick direction.

Thereafter, in FIG. 5B, by the player performing a touch operation on the touch panel 13 such that the player moves the finger from the contact point T2 to a contact point T3 which is in the right-forward direction from the contact point T2 relative to the drag direction da12, a previous contact point T2 and a current contact point T3 are set. In this case, the vector from the previous contact point T2 to the current contact point T3 is set as a movement vector. Then, the direction specified by the movement vector from the previous contact point T2 to the current contact point T3 is set as a drag direction da23. By performing the aforementioned step 47, a new stick direction sa23 is set using the drag direction da23, and the stick direction sa23 is the same as the drag direction da23. Namely, the direction in which the contact point T2 moves to the contact point T3 is set as a new stick direction.

As described above, by the process of setting a stick direction using a drag direction, when a contact point is continuously moving in a certain direction (the direction in which the point being touch by the player is moving; the right-forward direction in FIGS. 5A and 5B), the direction specified by a stick value (i.e., the direction in which the joystick is tilted) is set to the moving direction of the contact point (i.e., the right-forward direction). Accordingly, by moving indication coordinates in a certain direction, the player can determine the direction of a stick input without the need for him/her to be aware of the position of the origin. That is, the direction of a touch operation by the player serves as a stick direction, and thus the player can operate the touch panel 13 as if he/she were operating a joystick. Furthermore, since the origin which is conventionally set on a touch panel is not set in the present invention, and a contact point immediately before the current contact point is treated as the origin, the player can intuitively grasp the origin set on the touch panel 13. Accordingly, without visually checking the touch panel 13, the player can operate the touch panel 13 as if he/she were operating a joystick.

In the above-described embodiment, in order to realize, with the use of the touch panel 13, the same processing as processing performed during the operation of continuously outputting, when the lever of the joystick is held in a given position, a certain input, a stick direction is stored, and if a previous contact point and a current contact point are the same (i.e., the length of a movement vector is 0), the stick direction being stored is used without being updated; however, other parameters may be stored. For example, a previous contact point may be stored without being updated as long as a contact point does not move, and a stick direction may be calculated based on the relationship between the previous contact point and the contact point.

Although, in the above-described embodiment, the exact contact point on the touch panel 13 on which the player performs a touch operation is used in calculating a drag direction, tolerance may be given to an area around the contact point. Specifically, a point on the touch panel 13 on which the player performs a touch operation is freely arranged within the tolerance area, and if the touched point moves out of the tolerance area, the tolerance area moves in accordance with the movement of the touched point, and consequently, the contact point in the center of the tolerance area moves. By this, jiggling which may occur when the player performs a touch operation on the touch panel 13 can be eliminated.

Although, in the process of step 42, a position on the touch panel 13 on which the player performs a touch operation for the first time is set as a previous contact point, it is also possible to set a predetermined position (e.g., the center) on the touch panel 13 as an initial position of the previous contact point. In this case, since a drag direction can be set between a contact point on which the player performs a touch operation for the first time and an initial position of the previous contact point, it is possible to promptly start an operation which simulates the operation of a joystick.

Although, in the flowchart described in FIG. 3, once the player ends a touch operation on the touch panel 13 (“No” at step 40), the stick value is set to neutral, it is also possible to continuously process a stick value, which had been set before a touch operation ended, as a game parameter until a next touch operation is performed or until a given time has elapsed. In the case where the stick value is continuously processed as a game parameter until a next touch operation is performed, it becomes unnecessary for the player to continuously perform the same touch operation for a long period of time; namely, an operation in which the same operation is continuously performed is facilitated. In the case where the stick value is continuously processed as a game parameter until a given time has elapsed, even if a touch operation on the touch panel 13 is interrupted without player's intention (e.g., even if the player's finger is carelessly detached from the touch panel), the player can continuously proceed the game in the same operational state as before.

In the flowchart described in FIG. 3, when, after the player ends a touch operation on the touch panel 13, the player performs another touch operation again, a new previous contact point is set. Here, when a next touch operation is performed, a stick direction which had been set before the touch operation ended may be continuously used. For example, at step 51, a stick direction which had been stored at step 48 before the touch operation ended may be continuously stored. Then, when a touch operation is resumed, the process of step 49 may be performed using the stick direction. Generally, when the player's finger moves out of the area of the touch panel 13 while the player is performing a touch operation on the touch panel 13, it is likely that the player continues the same touch operation touching a different position on the touch panel 13. Even when resuming a touch operation as in the above case, since the stick direction is continuously outputted, the player can enjoy the game without the player's operation being interrupted.

Although, in the above-described embodiment, a touch panel is used as an input device which allows the player to perform an operation which simulates the operation of a joystick, other pointing devices may be used. Here, a pointing device is an input device for specifying an input position or coordinates on a screen. For example, using a mouse, a track pad, a track ball, or the like as an input device and using information about a screen coordinate system which is calculated using an output value outputted from the input device, the present invention can be realized as well. Note that in the case of using a mouse or the like as a pointing device, a touch state and a non-touch state may be associated with an on and off of a click button, respectively, and the process of calculating coordinates using an output value outputted from the mouse or the like may be performed by a game machine, or the like.

Although, in the above-described embodiment, the touch panel 13 is integrally provided to the game machine 1, needless to say, even if a game machine and a touch panel are composed independently of each other, the present invention can be realized. Furthermore, although, in the above-described embodiment, there are provided two displays, there may be provided a single display. Specifically, in the above-described embodiment, only a touch panel 13 may be simply provided without providing a second LCD 12. Alternatively, in the above-described embodiment, a second LCD 12 may not be provided and a touch panel 13 may be provided on a top surface of a first LCD 11.

Although, in the above-described embodiment, the touch panel 13 is integrally provided to the game machine 1, it is also possible to use an information processing device, such as a general personal computer, which uses a touch panel as one of its input devices. In this case, a program to be executed by a computer of the information processing device is not limited to a game program which is typically used in a game, and may be a generic program in which a stick value obtained by the aforementioned method is used in operation processing in the information processing device.

Although, in the above-described embodiment, only the direction of a stick input is determined, the amount of stick input (which corresponds to the amount of tilt of the lever) may be determined according to the speed of a drag input (here, in the case where there is no drag input, a certain amount of stick input may be set). Alternatively, the amount of stick input may be determined according to the distance between a reference point and a contact point on a touch panel, or may be controlled using button switches (14a, 14b), or the like.

While the invention has been described in detail, the foregoing description is in all aspects illustrative and not restrictive. It is understood that numerous other modifications and variations can be devised without departing from the scope of the invention.

What is claimed is:

1. A storage medium having stored thereon a game program to be executed by a computer of a game machine controlled by a pointing device which outputs coordinate information, the coordinate information being specified by an operation of a player and being based on a given coordinate system, wherein the game program causes the computer to perform:
a specified-coordinate setting step of setting specified coordinates in the coordinate system based on coordinate information outputted from the pointing device;
an input-direction setting step of setting, as an input direction used in game control, a direction in the coordinate system in which specified coordinates previously set at the specified-coordinate setting step move to currently set specified coordinates; and
a game control step of performing game control based on the input direction set at the input-direction setting step, and performing, if specified coordinates previously set at the specified-coordinate setting step and currently set specified coordinates are the same, game control using, as a current input direction, a same direction as a previous input direction set at the input-direction setting step.

2. The storage medium according to claim 1, wherein
at the game control step, only when same coordinate information is continuously outputted from the pointing device, game control is performed using, as a current input direction, a same direction as a previous input direction set at the input-direction setting step.

3. The storage medium according to claim 1, wherein
the game program further causes the computer to perform an input-direction storing step of updating and storing the input direction set at the input-direction setting step, according to the setting of the input direction,
at the input-direction setting step, if specified coordinates previously set at the specified-coordinate setting step and currently set specified coordinates are different, a direction in the coordinate system in which the previously set specified coordinates move to the currently set specified coordinates is set as the input direction and the input direction is stored at the input-direction storing step, and
at the game control step, game control is performed based on the input direction stored at the input-direction storing step.

4. The storage medium according to claim 3, wherein at the input-direction storing step, if output of coordinate information from the pointing device has ended, the stored input direction is initialized.

5. The storage medium according to claim 3, wherein
the game program further causes the computer to perform a specified-coordinate storing step of storing specified coordinates set at the specified-coordinate setting step, and
at the input-direction setting step, if specified coordinates previously set at the specified-coordinate setting step and stored at the specified-coordinate storing step are different from specified coordinates currently set at the specified-coordinate setting step, the input direction is set.

6. The storage medium according to claim 1, wherein
the game program further causes the computer to perform a peripheral area setting step of setting a peripheral area at a periphery of the specified coordinates set based on coordinate information outputted from the pointing device, and
at the specified-coordinate setting step, if a position indicated by coordinate information newly outputted from the pointing device is within the peripheral area, the specified coordinates are not changed, and if the position indicated by the newly outputted coordinate information is outside the peripheral area, the specified coordinates are changed based on the position indicated by the coordinate information.

7. The storage medium according to claim 1, wherein at the game control step, if output of coordinate information from the pointing device has ended, game control is continuously performed based on the input direction which had been set before the output of coordinate information ended.

8. A game machine controlled by a pointing device which outputs coordinate information, the coordinate information being specified by an operation of a player and being based on a given coordinate system, the game machine comprising:
specified-coordinate setting means of setting specified coordinates in the coordinate system based on coordinate information outputted from the pointing device;
input-direction setting means of setting, as an input direction used in game control, a direction in the coordinate system in which specified coordinates previously set by the specified-coordinate setting means move to currently set specified coordinates; and
game control means of performing game control based on the input direction set by the input-direction setting means, and performing, if specified coordinates previously set by the specified-coordinate setting means and currently set specified coordinates are the same, game control using, as a current input direction, a same direction as a previous input direction set by the input-direction setting means.

9. An input device for inputting information to a game machine which performs game control based on an input direction indicating a direction in a given coordinate system, the input device comprising:
coordinate information output means of outputting coordinate information which is specified by an operation of a player and based on the coordinate system;
specified-coordinate setting means of setting specified coordinates in the coordinate system based on coordinate information outputted from the coordinate information output means; and
input-direction setting means of setting, as an input direction used in game control, a direction in the coordinate system in which specified coordinates previously set by the specified-coordinate setting means move to currently set specified coordinates, wherein
the game machine performs game control based on the input direction set by the input-direction setting means, and performs, if specified coordinates previously set by the specified-coordinate setting means and currently set specified coordinates are the same, game control using, as a current input direction, a same direction as a previous input direction set by the input-direction setting means.

10. A storage medium having stored thereon a program to be executed by a computer of an information processing device controlled by a pointing device which outputs coordinate information, the coordinate information being specified by an operation of a user and being based on a given coordinate system, wherein the program causes the computer to perform:
a specified-coordinate setting step of setting specified coordinates in the coordinate system based on coordinate information outputted from the pointing device;
an input-direction setting step of setting, as an input direction used in operation processing, a direction in the coordinate system in which specified coordinates previously set at the specified-coordinate setting step move to currently set specified coordinates; and
an operation processing step of performing operation processing based on the input direction set at the input-direction setting step, and performing, if specified coordinates previously set at the specified-coordinate setting step and currently set specified coordinates are the same, operation processing using, as a current input direction, a same direction as a previous input direction set at the input-direction setting step.
